(19) United States
(12) Patent Application Publication
(10) Pub. No.: US 2008/0311925 A1
(43) Pub. Date: Dec. 18, 2008

(54) BASE STATION, MOBILE COMMUNICATION SYSTEM AND CHANNEL ASSIGNMENT METHOD

(75) Inventor: Tsuyoshi KOGAWA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/843,245

(22) Filed: Aug. 22, 2007

(30) Foreign Application Priority Data
Sep. 13, 2006 (JP) 2006-248594

(51) Int. Cl. H04Q 7/20; H04B 7/26

(52) U.S. Cl. 455/452.1; 455/512

(57) ABSTRACT

A base station communicates with plural terminals with using plural frequency channels having different bandwidths. The base station includes: a carrier-sensing unit that carrier-senses the plurality of frequency channels; a first calculating unit that estimates whether the frequency channels are used or not, and calculates first priorities of respective frequency channels; a second calculating unit that calculates a plurality of second priorities of respective communication frequency channels having a bandwidth to be used in communication with a terminal based on the first priorities of the communication frequency channels and the first priorities of reference frequency channels having a bandwidth wider than the communication frequency channels have; a third calculating unit that calculates an assignment order of the communication frequency channels based on the plural second priorities; and a channel assigning unit that assigns a communication frequency channel to the communication in accordance with the assignment order.

### CROSS-REFERENCE TO RELATED APPLICATIONS

This application is based upon and claims the benefit of priority from the prior Japanese Patent Applications No. 2006-248594, filed on Sep. 13, 2006; the entire contents of which are incorporate herein by reference.

### BACKGROUND

1. Field

The present invention relates to a base station, a mobile communication system, and a channel assignment method.

2. Related Art

In a conventional mobile communication system, in order to improve the frequency utilization efficiency, a base station dynamically assigns a frequency channel to be used in communication with a terminal, for each communication. For example, “Mobile communication (wave summit course)”, Ohmsha, Ltd., Hideichi Sasaoka (1998) discloses a channel segregation method for dynamically assigning a frequency channel.

In the channel segregation method, a base station first observes the use statuses of plural frequency channels, and sets a priority for each of the frequency channels. When a frequency channel is not used in communication, for example, the priority of the frequency channel is increased, and, when it is used, the priority is reduced.

In accordance with the priorities of the frequency channels, the base station assigns a frequency channel to communication with a terminal in descending order of priority. In this way, priorities of plural frequency channels are set, and a frequency channel is assigned to communication with a terminal in descending order of priority. Therefore, interference in communication between the base station and terminals can be reduced.

In the channel segregation method, in the case where frequency channels of various bandwidths exist, however, a call loss occurs sometimes (fractional line effect). For example, a mobile communication system in which frequency channels of bandwidths of w and 2w exist will be considered. In the case where a frequency band having a bandwidth of 3w is usable, when the bandwidth w at a center of the usable bandwidth 3w is assigned to communication with a terminal A requesting a frequency channel of the bandwidth w, the bandwidth 2w cannot be assigned to communication with a terminal B requesting a frequency channel of the bandwidth 2w, and a call loss occurs in communication with the terminal B.

For example, JP-A-7-245778 discloses a method in which an order of searching an unused frequency channel is set for each frequency channel bandwidth as a method of reducing such call loss. JP-A-7-245778 discloses a line setting method which is used in the case where two call types of different using rates of a line such as the full rate and the half rate exist.

In the line setting method, the order of searching a uses status of a frequency channel is set for each of calls of different using rates. The search orders for respective calls of different rates are set so that the searching orders are opposite in direction to each other. For example, with respect to the full rate, use status of each frequency channel is searched in descending order of frequency. On the other hand, with respect to the half rate, use status of each frequency channel is searched in ascending order of frequency.

As described above, the search orders for the full rate and the half rate are set to be opposite in direction to each other. Therefore, it is possible to prevent the frequency channel assignment for the half rate from interfering with that for the full rate, and hence the call loss can be suppressed.

In the line setting method disclosed in JP-A-7-245778, however, the frequency channel which is to be initially searched and the search order are restricted. Consequently, there is a problem in that it takes a long time for detecting a required unused frequency channel.

### SUMMARY

The present invention has been made in view of the above circumstances and provides, as an illustrative non-limiting embodiment, a base station, mobile communication system, and channel assignment method in which, even in a mobile communication system where frequency channels of various bandwidths exist, the call loss can be suppressed, and an unused channel can be detected in a short time.

According an embodiment, a base station communicates with a plurality of terminals with using a plurality of frequency channels having different bandwidths. The base station comprises: a carrier-sensing unit that carrier-senses the plurality of frequency channels; a first calculating unit that estimates whether the carrier-sensed frequency channels are used in communication or not, respectively, and calculates a plurality of first priorities of respective frequency channels so that a first priority of a frequency channel which is estimated to be used is low and a first priority of a frequency channel which is estimated not to be used is high; a priority storing unit that stores the first priorities of the plurality of frequency channels; a second calculating unit that calculates a plurality of second priorities of respective communication frequency channels among the plurality of frequency channels having a bandwidth to be used in a communication with a terminal, based on the first priorities; a third calculating unit that calculates an assignment order of the communication frequency channels based on the plurality of second priorities; and a channel assigning unit that estimates whether the communication frequency channels are usable or not in the communication with the terminal in order of the assignment order, and when a communication frequency channel is estimated to be usable, assigns the communication frequency channel to the communication with the terminal. The second calculating unit calculates the second priorities of the communication frequency channels based on the first priorities of the communication frequency channels stored in the priority storing unit and the first priorities of reference frequency channels having a bandwidth wider than the bandwidth of the communication frequency channels.

According to an embodiment, a mobile communication system comprises: a plurality of terminals; and a base station configured to communicate with the terminals with using a plurality of frequency channels having different bandwidths. The plurality of terminals transmit signals to the base station, each of the signals including a start request for a communication with the base station and information indicating a bandwidth to be used in the communication. The base station comprises: a receiving unit that receives the signals from the terminals; a carrier-sensing unit that carrier-senses the plurality of frequency channels; a first calculating unit that estimates whether the carrier-sensed frequency channels are used in communication or not, respectively, and calculates a plurality of first priorities of respective frequency channels so that a first priority of a frequency channel which is estimated to be used is low and a first priority of a frequency channel which is estimated not to be used is high; a priority storing unit that stores the first priorities of the plurality of frequency channels; a second calculating unit that calculates a plurality of second priorities of respective communication frequency channels having a bandwidth to be used in a communication with a terminal among the plurality of frequency channels based on the first priorities; a third calculating unit that calculates an assignment order of the communication frequency channels based on the plurality of second priorities; and a channel assigning unit that estimates whether the communication frequency channels are usable or not in the communication with the terminal in order of the assignment order, and when a communication frequency channel is estimated to be usable, assigns the communication frequency channel to the communication with the terminal. The second calculating unit calculates the second priorities of the communication frequency channels based on the first priorities of the communication frequency channels stored in the priority storing unit and the first priorities of reference frequency channels having a bandwidth wider than the bandwidth of the communication frequency channels.

According to an embodiment, a channel assignment method for a base station to assign a plurality of frequency channels having different bandwidths to a plurality of terminals for communication, comprises: carrier-sensing the plurality of frequency channels; estimating whether the carrier-sensed frequency channels are used in communication or not, respectively to calculate a plurality of first priorities of respective frequency channels so that a first priority of a frequency channel which is estimated to be used is low and a first priority of a frequency channel which is estimated not to be used is high; when the base station receives a signal including a start request for a communication from one of the terminals, calculating a plurality of second priorities of respective communication frequency channels among the plurality of frequency channels based on the first priorities, the communication frequency channels having a bandwidth to be used in a communication with a terminal; calculating an assignment order of the communication frequency channels based on the plurality of second priorities; and estimating whether the communication frequency channels are usable or not in the communication with the terminal in order of the assignment order, and when a communication frequency channel is estimated to be usable, assigning the communication frequency channel to the communication with the terminal. The second priorities of the communication frequency channels are calculated based on the first priorities of the communication frequency channels and the first priorities of reference frequency channels having a bandwidth wider than the bandwidth of the communication frequency channels.

As one of advantage, even in a mobile communication system where frequency channels of various bandwidths exist, the call loss can be suppressed, and an unused channel can be detected in a short time.

### BRIEF DESCRIPTION OF THE DRAWINGS

In the accompanying drawings:

FIG. 1 is a diagram showing a mobile communication system of Embodiment 1 of the present invention;

FIG. 2 is a diagram showing a system bandwidth assigned to the mobile communication system of Embodiment 1;

FIG. 3 is a block diagram showing the configuration of a base station in Embodiment 1;

FIG. 4 is a block diagram showing the configuration of a carrier-sensing unit in Embodiment 1;

FIG. 5 is a diagram showing the configuration of a priority storing unit 16 in Embodiment 1;

FIG. 6 is a diagram showing the configuration of an assignment order storing unit 19 in Embodiment 1;

FIG. 7 is a flowchart showing the operation of the base station in Embodiment 1;

FIG. 8 is a view illustrating a priority updating process in Embodiment 1;

FIGS. 9A to 9C are views illustrating a priority number calculating process in Embodiment 1;

FIG. 10 is a flowchart showing an assigning process in Embodiment 1;

FIG. 11 is a block diagram showing the configuration of a carrier-sensing unit in Embodiment 2 of the present invention;

FIG. 12 is a flowchart showing the operation of a base station in Embodiment 2;

FIG. 13 is a block diagram showing the configuration of a base station in Embodiment 3 of the present invention; and

FIG. 14 is a flowchart showing the operation of the base station in Embodiment 3.

### DETAILED DESCRIPTION

Hereinafter, embodiments of the present invention will be described with reference to the accompanying drawings.

### Embodiment 1

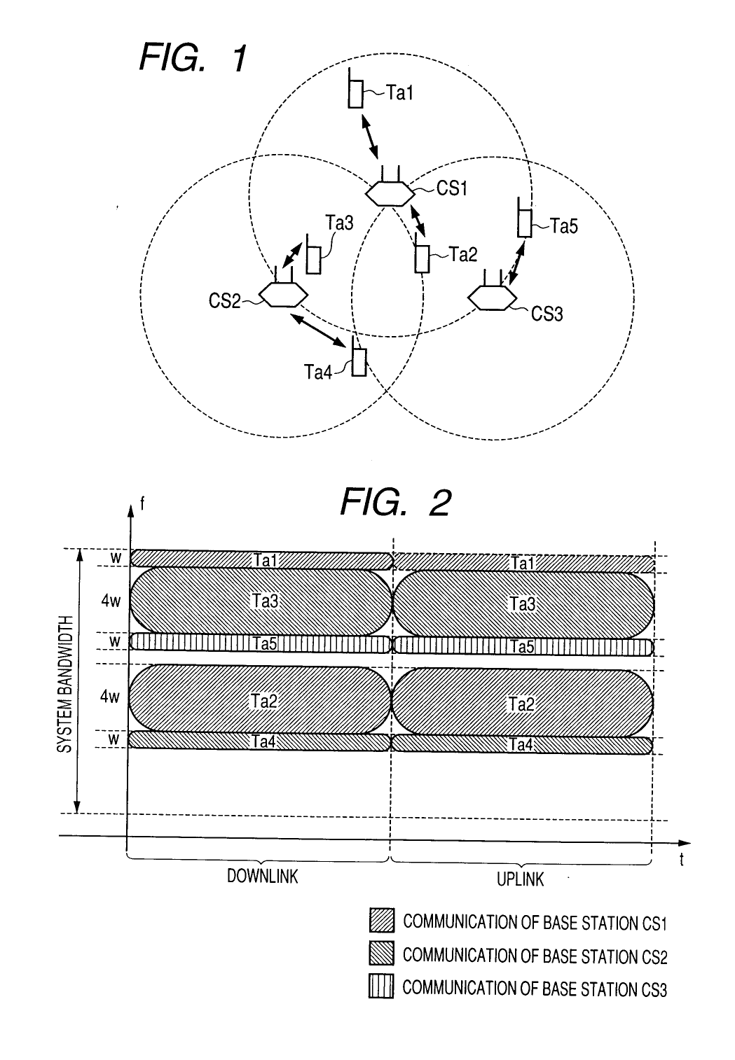

FIG. 1 is a diagram showing a configuration example of a mobile communication system of Embodiment 1. The mobile communication system includes plural base stations CS1, CS2, CS3 . . . , and plural terminals Ta1, Ta2, Ta3 . . . which are configured to communicate with the base stations CS1, CS2, CS3 . . . . The base stations CS1, CS2, CS3 . . . are configured to communicate with the plural terminals Ta1, Ta2, Ta3 . . . which exist in a communication area (an area indicated by the broken line in FIG. 1), with using frequency channels of various bandwidths. In the example shown in FIG. 1, the base station CS1 communicates with the terminals Ta1, Ta2, the base station CS2 communicates with the terminals Ta3, Ta4, and the base station CS3 communicates with the terminal Ta5.

FIG. 2 shows relationships between a system bandwidth and slots which are used in communication by the base stations CS1 to CS3 and the terminals Ta1 to Ta5. A system band of a constant bandwidth is allocated to the mobile communication system. The base stations perform communication while dividing the system band into frequency channels of a bandwidth of w or 4w.

In the example shown in FIG. 2, the base station CS1 performs communication with the terminal Ta1 in a Time Division Duplex (TDD) system with using the frequency channel of the bandwidth w. The base station CS1 transmits a signal to the terminal Ta1 through a downlink slot, and receives a signal transmitted by the terminal Ta1 through an uplink slot. The base station CS1 performs communication with the terminal Ta2 with using the frequency channel of the bandwidth 4w.

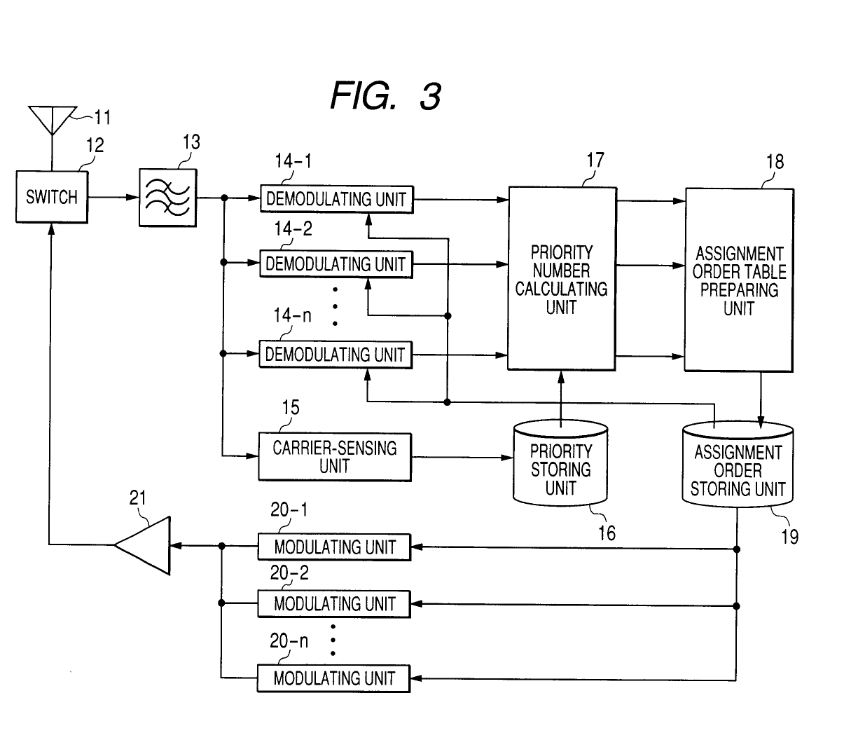

Then, the configuration of the base station CS1 of Embodiment 1 will be described with reference to FIGS. 3 to 6. The configurations of the base stations CS2, CS3 are similar to the configuration of the base station CS1, and therefore their description is omitted.

The base station CS1 shown in FIG. 3 comprises: an antenna 11 which is used in transmission and reception; a switch SW12 which switches between transmission and reception; a system bandwidth Band-Pass Filter (BPF) 13 which reduces the reception power outside the system bandwidth; demodulating units 14-1 to 14-n (n is the number of terminals with which the base station CS1 can simultaneously communicate) for receiving and demodulating a transmission signal from a terminal; a carrier-sensing unit 15 which carrier-senses frequency channels in each elapse of a predetermined time period, and which prepares a priority table for each bandwidth that will be described later; a priority table storing unit 16 which stores the priority tables prepared by the carrier-sensing unit 15; a priority number calculating unit 17 which refers the priority storing unit 16 and calculates a priority number U of each communication frequency channel which is a frequency channel of a bandwidth that is to be used in communication with a terminal; an assignment order table preparing unit 18 which prepares an assignment order table on the basis of a result of the calculation in the priority number calculating unit 17; an assignment order storing unit 19 which stores the assignment order table; modulating units 20-1 to 20-n which prepare signals to be transmitted to the terminals; a power amplifier 21 which amplifies the power of a transmission signal.

The system bandwidth BPF 13 reduces the reception power of a reception signal outside the system bandwidth, which is received through the antenna 11, and supplies the power-reduced reception signal to the demodulating units 14-1 to 14-n and the carrier-sensing unit 15. The demodulating units 14-1 to 14-n perform processes such as demodulation on the reception signal which has passed through the system bandwidth BPF 13, and obtains reception data. The demodulating units 14-1 to 14-n supply the obtained reception data to an upper layer I/F which is not shown. When the reception data include a communication start request from a terminal, the demodulating units 14-1 to 14-n notify the priority number calculating unit 17 of a trigger signal and a bandwidth requested by the terminal, so as to calculate the priority number U of each frequency channel of the bandwidth requested by the terminal.

The priority number calculating unit 17 calculates the priority numbers U of frequency channels of bandwidths notified by the demodulating units 14-1 to 14-n, and supplies a result of the calculation to the assignment order table preparing unit 18. Based on the priority numbers U calculated by the priority number calculating unit 17, the assignment order table preparing unit 18 prepares an assignment order table for each of the demodulating units which are to communicate with the terminal, and the table is stored into the assignment order storing unit 19.

The modulating units 20-1 to 20-n demodulate transmission data such as control information and data supplied from the upper layer I/F which is not shown, to produce a transmission signal. The transmission signal is supplied to the power amplifier 21 to be power-amplified by the power amplifier 21, and then transmitted through the antenna 11.

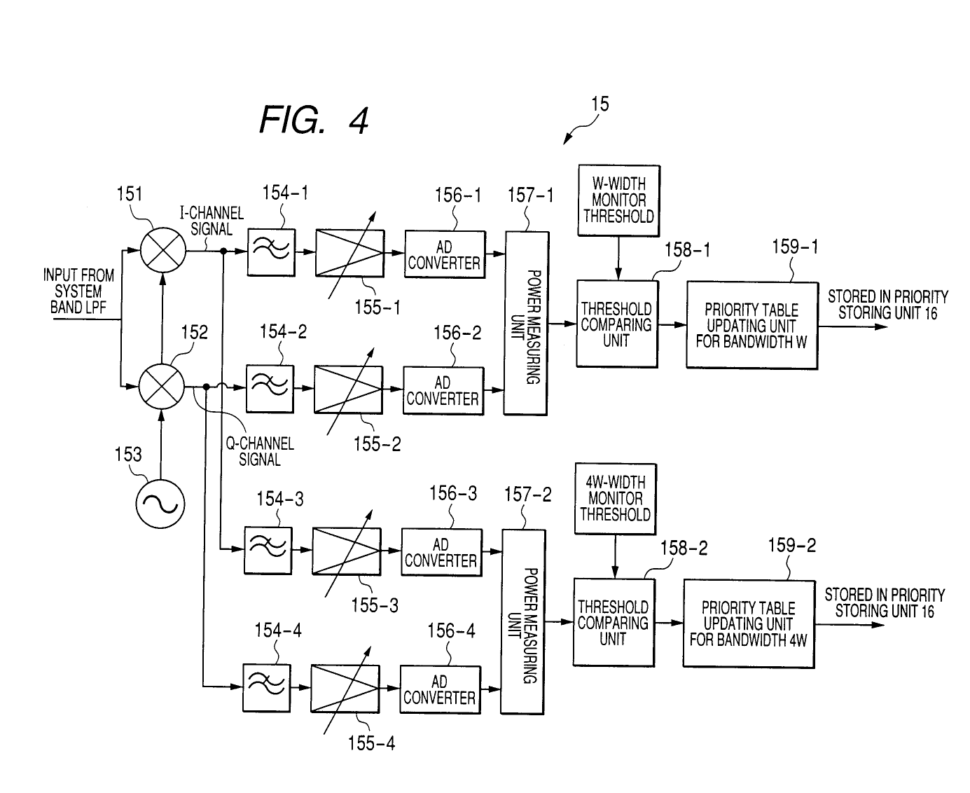

The carrier-sensing unit 15 of the base station CS1 will be described in detail with reference to FIG. 4.

The carrier-sensing unit 15 shown in FIG. 4 comprises: a quadrature demodulator 151 which quadrature demodulates the high-frequency signal supplied from the system band BPF 13, to output an I-channel signal; a quadrature demodulator 152 which quadrature demodulates the high-frequency signal to output a Q-channel signal; a local oscillator 153 which produces a sinusoidal wave to be used in the quadrature demodulation of the high-frequency signal in the quadrature demodulators 151, 152; w-width monitor Low-Pass Filters (LPFs) 154-1, 154-2 which reduce the reception power outside the bandwidth w; 4w-width monitor LPFs 154-3, 154-4 which reduce the reception power outside the bandwidth 4w; variable gain amplifiers 155-1 to 155-4 which adjust the gains of signals that have passed through the w-width monitor LPFs 154-1, 154-2 and the 4w-width monitor LPFs 154-3, 154-4, respectively; AD converters 156-1 to 156-4 which convert an analog signal to a digital signal; power measuring units 157-1, 157-2 which measure the reception power from signals supplied from the AD converters 156-1 to 156-4; threshold comparing units 158-1, 158-2 which compare the reception powers measured by the power measuring units 157-1, 157-2, with a threshold that is previously stored; a w-width priority table updating unit 159-1 which updates the priority table for the bandwidth w on the basis of a result of the comparison by the threshold comparing unit 158-1, and stores the updated table into the priority storing unit 16; and a 4w-width priority table updating unit 159-2 which updates the priority table for the bandwidth 4w on the basis of a result of the comparison by the threshold comparing unit 158-2, and stores the updated table into the priority storing unit 16.

The quadrature demodulator 151 converts the high-frequency signal supplied from the system band BPF 13 to the I-channel signal with using the sinusoidal wave supplied from the local oscillator 153, and outputs the I-channel signal to the w-width monitor LPF 154-1 and the 4w-width monitor LPF 154-3. Similarly, the quadrature demodulator 152 converts the high-frequency signal supplied from the system band BPF 13 to the Q-channel signal with using the sinusoidal wave supplied from the local oscillator 153, and outputs the Q-channel signal to the w-width monitor LPF 154-2 and the 4w-width monitor LPF 154-4.

The w-width monitor LPFs 154-1, 154-2 reduce the reception powers of the input I- and Q-channel signals outside the bandwidth w, and output the resulting signals to the variable gain amplifiers 155-1, 155-2, respectively. The variable gain amplifiers 155-1, 155-2 adjust the gains of the I- and Q-channel signals which have passed through the w-width monitor LPFs 154-1, 154-2, to a level at which the signals can be input to the AD converters 156-1, 156-2 in the subsequent stage, and output the adjusted signals to the AD converters 156-1, 156-2, respectively. The AD converters 156-1, 156-2 convert the input analog signals or I- and Q-channel signals to digital signals, and supply a result of the conversion to the power measuring unit 157-1.

The power measuring unit 157-1 measures the power of the reception signal on the basis of the I- and Q-channel signals supplied from the AD converters 156-1, 156-2, and outputs a result of the measurement to the threshold comparing unit 158-1. The threshold comparing unit 158-1 to which the measurement result is input compares the measurement result of the power measuring unit 157-1 with a w-width monitor threshold Th-w which is previously stored, and outputs a result of the comparison to the w-width priority table updating unit 159-1. The w-width priority table updating unit 159-1 updates the priority table for the bandwidth w stored in the priority storing unit 16, on the basis of the input comparison result.

The I-channel signal output from the quadrature demodulator 151 is supplied to the w-width monitor LPF 154-1, and also to the 4w-width monitor LPF 154-3. Similarly, the Q-channel signal output from the quadrature demodulator 152 is supplied to the 4w-width monitor LPF 154-4.

The 4w-width monitor LPFs 154-3, 154-4 reduce the reception powers of the input I- and Q-channel signals outside the bandwidth 4w, and output the resulting signals to the variable gain amplifiers 155-3, 155-4, respectively. The variable gain amplifiers 155-3, 155-4 adjust the gains of the I- and Q-channel signals to a level at which the signals can be input to the AD converters in the subsequent stage, and output the adjusted I- and Q-channel signals to the AD converters 156-3, 156-4, respectively. The AD converters 156-3, 156-4 convert the input analog signals or I- and Q-channel signals to digital signals, and supply a result of the conversion to the power measuring unit 157-2.

The power measuring unit 157-2 measures the power of the reception signal on the basis of the I- and Q-channel signals supplied from the AD converters 156-3, 156-4, and outputs a result of the measurement to the threshold comparing unit 158-2. The threshold comparing unit 158-2 to which the measurement result is input compares the measurement result of the power measuring unit 157-2 with a 4w-width monitor threshold Th-4w which is previously stored, and outputs a result of the comparison to the 4w-width priority table updating unit 159-2. The 4w-width priority table updating unit 159-2 updates the priority table for the bandwidth 4w stored in the priority storing unit 16, on the basis of the input comparison result.

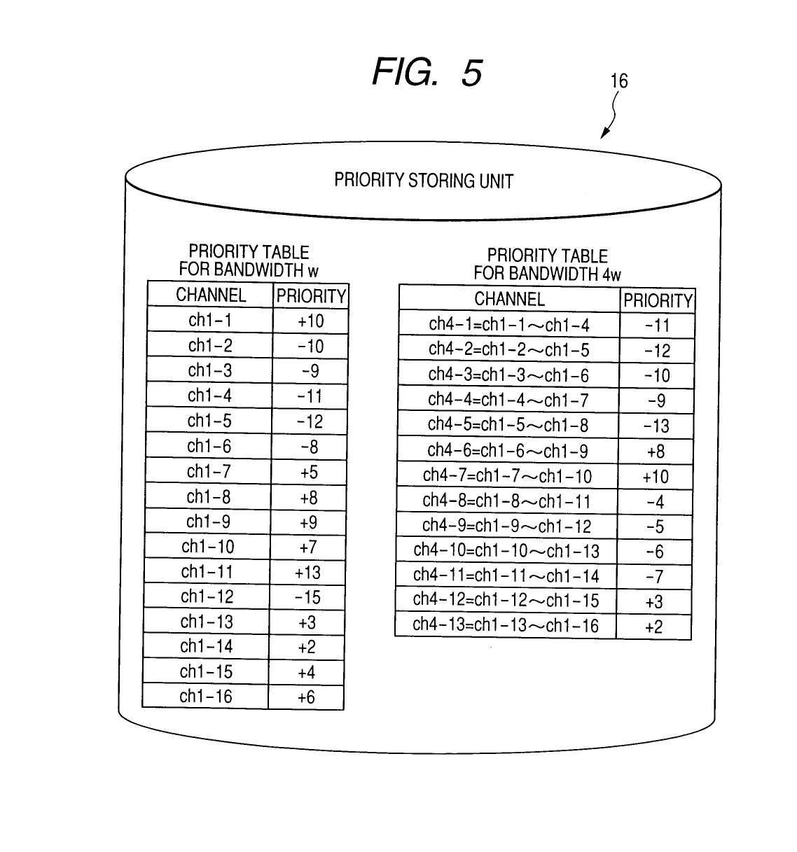

Next, the priority storing unit 16 will be described in detail with reference to FIG. 5. The priority storing unit 16 shown in FIG. 5 holds a priority table which stores priorities of frequency channels ch1-1 to ch1-m of the bandwidth w included in the system band, and frequency channels ch4-1 to ch4-M of the bandwidth 4w (in FIG. 5, m=16 and M=13).

A frequency channel ch4-i of the bandwidth 4w corresponds to four consecutive frequency channels ch1-i to ch1-i+3 (i=1, . . . , 13). For example, the frequency channel ch4-1 corresponds to the frequency channel ch1-1 to the frequency channel ch1-4, and the frequency channel ch4-2 corresponds to the frequency channels ch1-2 to ch1-5.

The priority table for the bandwidth w stores the priorities of the frequency channels ch1-1 to ch1-16. As a priority of a frequency channel has a larger value, the usage rate is lower, and this means that the priority of channel assignment is higher. In the example shown in FIG. 5, the priority of the frequency channel ch1-1 is “+10”, and that of the frequency channel ch1-2 is “−10”. Therefore, the frequency channel ch1-1 is higher in priority than the frequency channel ch1-2.

The priority table for the bandwidth 4w stores the priorities of the frequency channels ch4-1 to ch4-M. For example, the priority table for the bandwidth 4w shown in FIG. 5 stores the priority “−11” of the frequency channel ch4-1 (corresponding to the frequency channels ch1-1 to ch1-4 of the bandwidth w), and also the priority “−12” of the frequency channel ch4-2 (corresponding to the frequency channels ch1-2 to ch1-5 of the bandwidth w).

The priority tables for the bandwidths w, 4w are updated after each elapse of a predetermined time period. The process of updating the priority tables will be described later.

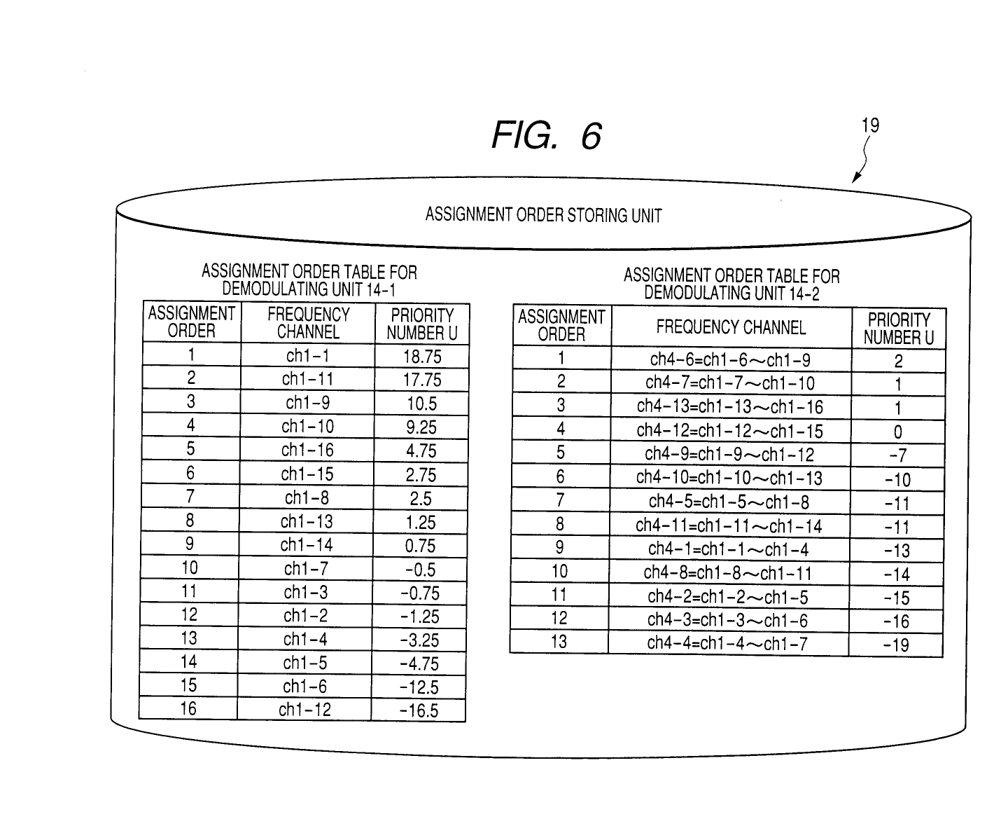

Next, the assignment order storing unit 19 will be described in detail with reference to FIG. 6. When a communication request is transmitted by a terminal, the assignment order table preparing unit 18 prepares an assignment order table according to a demodulating unit to communicate with the terminal, and stores the prepared assignment order table into the assignment order storing unit 19. Therefore, the assignment order storing unit 19 holds the assignment order table prepared by the assignment order table preparing unit 18. FIG. 6 shows an example of assignment order tables which are stored in the assignment order storing unit 19 in the case where the demodulating unit 14-1 communicates with the terminal Ta1 with using the frequency channel of the bandwidth w, and the demodulating unit 14-2 communicates with the terminal Ta2 with using the frequency channel of the bandwidth 4w.

Each of the assignment order tables correspondingly stores, in order of the assignment order, frequency channels to be assigned and priority numbers U. From the assignment order table of the demodulating unit 14-1 shown in FIG. 6, for example, it will be seen that the assignment order of the frequency channel ch1-1 (the priority number U is 18.75) is the first, and that of the next frequency channel ch1-11 (the priority number U is 17.75) is the second. The process of assigning a frequency channel in accordance with the assignment order table will be described later in detail.

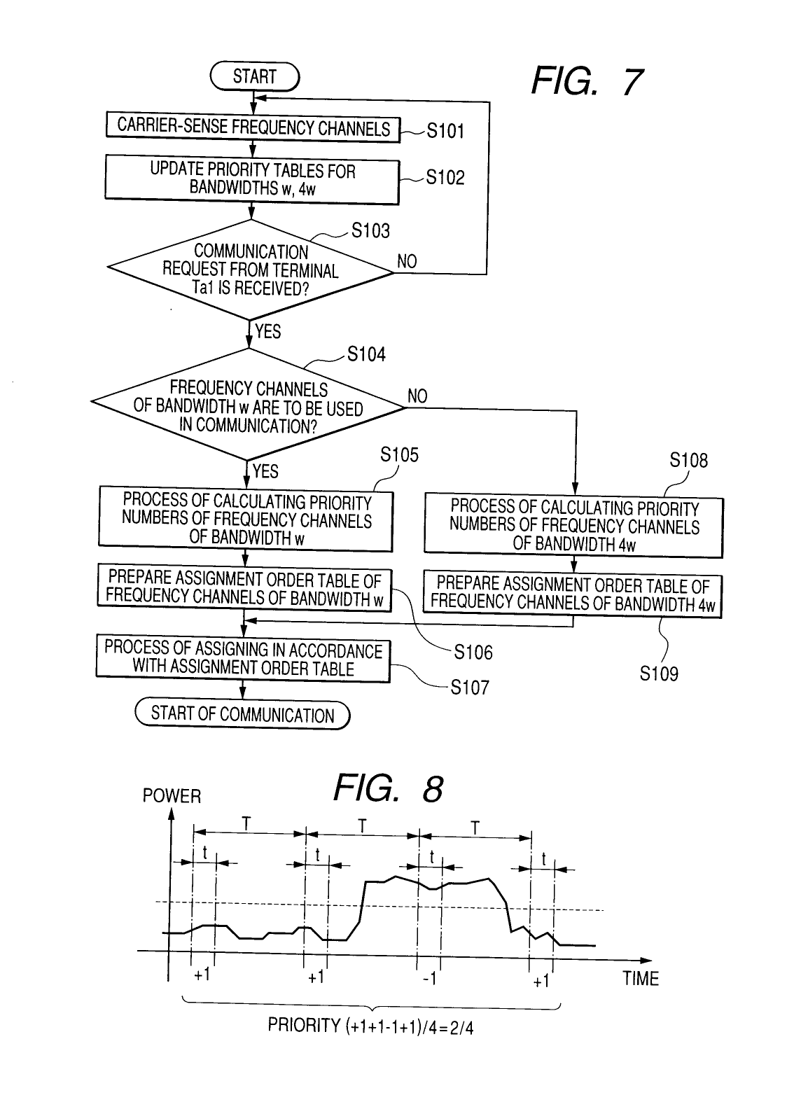

Next, the operation of the base station CS1 will be described with reference to FIG. 7. FIG. 7 is a flowchart showing the operation conducted before the base station CS1 starts communication with the terminal Ta1.

It is assumed that, when a communication request is issued from the terminal Ta1, the base station CS1 performs communication with the terminal Ta1 while assigning the frequency channels ch1-1 to ch1-16 of the bandwidth w. Information indicating that which of the frequency channel of the bandwidth w or that of the bandwidth 4w is used in the communication is notified by the terminal Ta1. The case where the base station CS1 communicates with the terminal Ta1 will be described. Also communications between the base stations CS2, CS3 and the terminals Ta2 to Ta5 are performed in the same manner.

First, until the communication request from the terminal Ta1 is received, the base station CS1 carrier-senses the frequency channels ch1-1 to ch1-16, ch4-1 to ch4-13 of the system band (step S101), and updates the both priority tables for the bandwidths w, 4w on the basis of a result of the carrier sense (step S102). The priority updating process will be described later in detail.

Next, the base station CS1 estimates whether the communication request from the terminal Ta1 is received or not (step S103). If the communication request from the terminal Ta1 is not received (No in step S103), the process returns to step S101 to carrier-sense the frequency channels after each elapse of a predetermined time period.

By contrast, if the communication request from the terminal Ta1 is received (Yes in step S103), it is estimated whether the terminal Ta1 notifies that the frequency channels of the bandwidth w are to be used in communication or not (step S104). If the frequency channels of the bandwidth w are to be used in communication (Yes in step S104), the priority number calculating unit 17 of the base station CS1 refers the priority tables for the bandwidths w, 4w, and calculates the priority numbers U of the frequency channels ch1-1 to ch1-16 (step S105). The process of calculating the priority numbers will be described later in detail.

Then, the assignment order table preparing unit 18 sorts the frequency channels ch1-1 to ch1-16 calculated by the priority number calculating unit 17, in descending order of the priority numbers U, and prepares the assignment order table (step S106). In accordance with the assignment order table, the base station CS1 assigns a frequency channel to communication with the terminal Ta1 (step S107), and starts the communication. The frequency channel assigning process will be described later in detail.

If the terminal Ta1 does not notify that the frequency channels of the bandwidth w are to be used in communication (No in step S104), communication is performed with using the frequency channels of the bandwidth 4w. Therefore, the priority number calculating unit 17 of the base station CS1 refers the priority table for the bandwidth 4w, and calculates the priority numbers U of the frequency channels ch4-1 (ch1-1 to ch1-4) to ch4-13 (ch1-13 to ch1-16) (step S108).

Then, the assignment order table preparing unit 18 sorts the frequency channels ch4-1 to ch4-13 calculated by the priority number calculating unit 17, in descending order of the priority numbers U, and prepares the assignment order table (step S109). In accordance with the assignment order table, the base station CS1 assigns a frequency channel to communication with the terminal Ta1 (step S107), and starts the communication.

As described above, the priority number calculating unit 17 calculates the priority numbers U in response to the communication request from a terminal. The calculation amount in the base station is reduced compared with a case where the priority numbers U is calculated after each elapse of a predetermined time period.

Next, the process of updating the priority will be described in detail with reference to FIG. 8.

The carrier-sensing unit 15 carrier-senses a part of the frequency channels ch1-1 to ch1-16, ch4-1 to ch4-13 after each elapse of a predetermined time period, and updates the priority table for the bandwidth w or 4w.

Specifically, after elapse of a predetermined time period, the carrier-sensing unit 15 receives signals which are transmitted with using the frequency channel ch1-j (j=1, 2, . . . , 16), and measures the powers of the reception signals. Next, among the measured powers, a reception power in a given time period t (hereinafter, referred to as monitor time period t) is compared with the w-width monitor threshold Th-w which is previously stored. If a result of the comparison shows that the reception power in the monitor time period t is equal to or smaller than the w-width monitor threshold Th-w, it is determined that the frequency channel ch1-j is an unused frequency channel and the priority is “+1”. By contrast, if the reception power in the monitor time period t is larger than the w-width monitor threshold Th-w, it is determined that the frequency channel ch1-j is used, and the priority is set to “−1”. This comparison is performed at a given time interval T, an average of priorities of past p times is calculated, and the average is set as the priority of the frequency channel ch1-j.

FIG. 8 shows an example in the case where the reception power of the frequency channel ch1-1 is carrier-sensed for a constant time period. In this example, it is assumed that the priority of the frequency channel ch1-1 is calculated from comparison results of past 4 times. In this case, the carrier-sensing unit 15 compares the reception power in the monitor time period t with the w-width monitor threshold Th-w after each elapse of the given time interval T. As a result of the comparison, the priorities are “+1”, “+1”, “−1”, and “+1”. Therefore, the priority of the frequency channel ch1-1 is “0.5” which is an average “(1+1−1+1)/4” of the priorities of past 4 times. The carrier-sensing unit 15 updates the priority of the priority table for the bandwidth w stored in the priority storing unit 16, to the calculated value.

In the above, the process of updating the priority table for the frequency channels of the bandwidth w has been described. The process for the frequency channels of the bandwidth 4w is performed in the same manner. The example in the case where the carrier-sensing unit carrier-senses one frequency channel has been described. Alternatively, in the case where plural frequency channels can be carrier-sensed, priorities of plural frequency channels may be updated at one time.

Next, the process of calculating the priority numbers in the priority number calculating unit 17 will be described in detail.

When the trigger signal and the bandwidth w of the frequency channel requested by the terminal Ta1 are notified by the demodulating unit 14-1, the priority number calculating unit 17 refers the priority tables for the bandwidths w, 4w, and calculates the priority number U_{w}(f) of a frequency channel having a center frequency f in the following expression (1).

U_{w}(f)=Y_{w}(f)−αZ_{4w}(f) (1)

where Y_{w}(f) is the priority of a frequency channel having the bandwidth w and the center frequency f, and obtained by referring the priority table for the bandwidth w, and Z_{4w}(f) indicates the maximum value of the priorities of frequency channels including the frequency f in the frequency channels of the bandwidth 4w, and obtained by referring the priority table for the bandwidth 4w. Furthermore, α is a real number satisfying the relationship of 0≦α≦1.

With reference to the priority tables for the bandwidths w, 4w shown in FIG. 5, an example of the case where the priority number U_{w}(f1) of the frequency channel ch1-4 having a center frequency f1 will be described. It is assumed that α=½.

First, since Y_{w}(f1) is the priority of the frequency channel ch1-4, the priority table for the bandwidth w of FIG. 5 is referred, and it is found that Y_{w}(f1)=−11. Next, frequency channels of the bandwidth 4w including the center frequency f1 of the frequency channel ch1-4 are the frequency channels ch4-1, ch4-2, ch4-3, ch4-4, and therefore Z_{4w}(f1) is the maximum value of the priorities of the frequency channels ch4-1 to ch4-4, i.e., Z_{4w}(f1)=−9 (in the case of the frequency channel ch4-4). Consequently, the priority number U_{w}(f1) of the frequency channel ch1-4 is −6.5 wherein U_{w}(f1)=−11−(−9)/2=−6.5. Similarly, the priority number calculating unit 17 calculates the priority numbers U of the frequency channels ch1-1 to ch1-16.

It is assumed that the priority numbers U_{4w} of the frequency channels ch4-1 to ch4-13 of the bandwidth 4w are the priorities of the frequency channels ch4-1 to ch4-13 stored in the priority table for the bandwidth 4w.

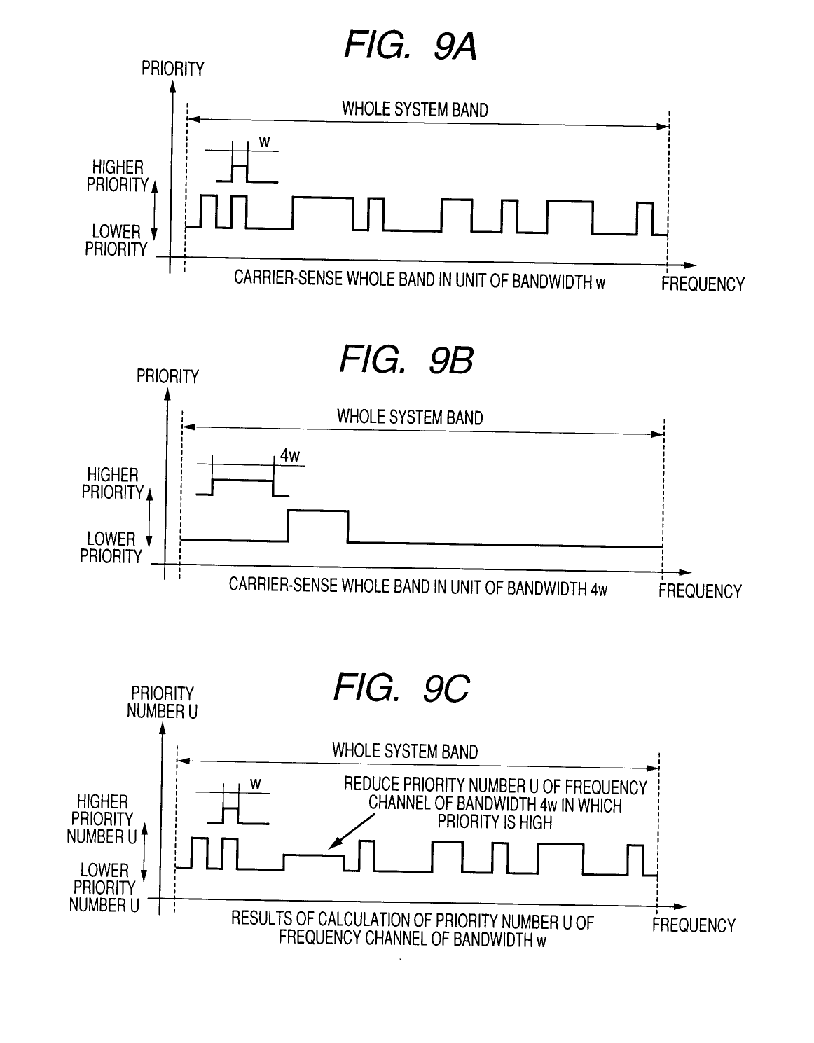

Referring to FIGS. 9A to 9C, the concept that the priority number calculating unit 17 calculates the priority number U of the bandwidth w with reference to the priority tables for the bandwidths w, 4w will be described. FIG. 9A shows an example in which the carrier-sensing unit 15 carrier-senses the system band in the unit of the bandwidth w. In FIG. 9A, the ordinate indicates the priority, and the abscissa indicates the frequency. Similarly, FIG. 9B shows an example in which the carrier-sensing unit 15 carrier-senses the system band in the unit of the bandwidth 4w.

At this time, when the priority numbers U of the frequency channels ch1-1 to ch1-16 of the bandwidth w are calculated in accordance with the expression (1), as shown in FIG. 9C, the priority numbers U are reduced as compared with other frequency channels, in a portion where four frequency channels are continuous to one another.

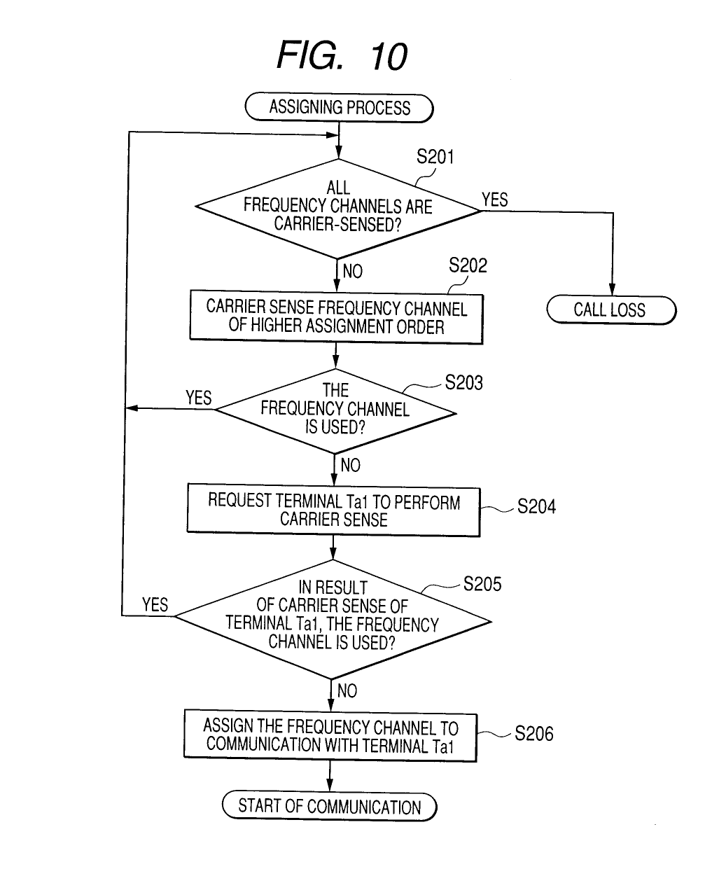

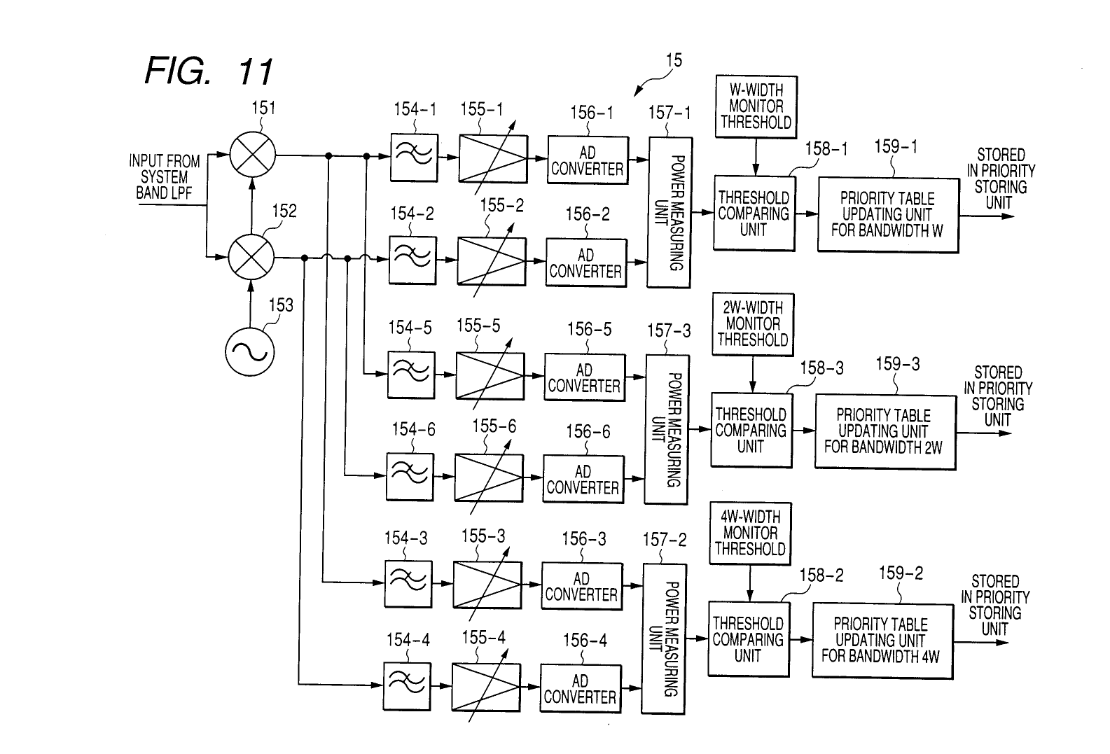

Then, the process of assigning a frequency channel will be described with reference to FIG. 10. It is assumed that the base station CS1 uses the frequency channels of the bandwidth w, and communicates with the terminal Ta1 through the demodulating unit 14-1.

The assignment order table preparing unit 18 prepares the assignment order table in accordance with the flowchart shown in FIG. 7, and the demodulating unit 14-1 performs the process of assigning a frequency channel in accordance with the assignment order table.

First, the demodulating unit 14-1 determines whether carrier sense has been performed on all of the frequency channels ch1-1 to ch1-16 of the bandwidth w or not (step S201). If carrier sense has been performed on all of the frequency channels ch1-1 to ch1-16 (Yes in step S201), an assignable frequency channel does not exist, and a call loss occurs.

On the other hand, if a frequency channel on which carrier sense has not been performed exists (No in step S201), the demodulating unit 14-1 refers the assignment order table, selects a frequency channel having the highest order of the assignment order is selected from the frequency channels on which carrier sense has not been performed, and performs carrier sense (step S202). Here, it is assumed that carrier sense is performed on the frequency channel ch1-1.

Next, from a result of the carrier sense in step S202, it is estimated whether the frequency channel ch1-1 is already used in communication or not (step S203). If the frequency channel ch1-1 is already used in communication (Yes in step S203), the process returns to step S201.

On the other hand, if the frequency channel ch1-1 is not used in communication (No in step S203), the demodulating unit 14-1 requests the terminal Ta1 with which the base station communicates to perform carrier sense on the frequency channel ch1-1 (step S204). This can be realized by, in response to the notification from the demodulating unit 14-1, transmitting a carrier sense request signal from the modulating unit 20-1 to the terminal Ta1. For example, the demodulating unit 14-1 notifies the modulating unit 20-1 to carrier-sense a frequency channel having a k-th assignment order, and the modulating unit 20-1 refers the assignment order table, and requests the terminal Ta1 to carrier-sense the frequency channel ch1-1.

Next, after receiving a result of the carrier sense which is performed on the frequency channel ch1-1 by the terminal Ta1, the demodulating unit 14-1 estimates from a result of the carrier sense of the terminal Ta1 whether the frequency channel ch1-1 is used or not (step S205). If it is estimated that the frequency channel ch1-1 is used (Yes in step S205), the process returns to step S201.

On the other hand, if it is estimated that the frequency channel is not used (No in step S205), the frequency channel ch1-1 is assigned to communication with the terminal Ta1 (step S206), and communication with the terminal Ta1 is started.

In step S205, based on the carrier sense result transmitted by the terminal Ta1, the demodulating unit 14-1 estimates use or nonuse of the frequency channel ch1-1. Alternatively, the terminal Ta1 may perform the estimation, and transmit a result of the estimation to the base station CS1.

As described above, according to Embodiment 1, when the priority numbers U of the frequency channels ch1-1 to ch1-16 of the bandwidth w are to be calculated, the priorities of the frequency channels ch4-1 to ch4-13 of the bandwidth 4w are referred. The priority numbers U of ones of the frequency channels ch1-1 to ch1-16 corresponding to higher-priority ones of the frequency channels 4-1 to 4-13 are set to be low, and the priority numbers U of ones of the frequency channels ch1-1 to ch1-16 corresponding to lower-priority ones are set to be high. In the case where the frequency channels of the bandwidth w are to be assigned to communication, therefore, a frequency channel which is not assigned as a frequency channel of the bandwidth 4w is preferentially assigned. Even in the case where frequency channels of different bandwidths exist, consequently, the call loss can be suppressed.

Furthermore, the priority numbers U of the frequency channels ch1-1 to ch1-16 and the frequency channels ch4-1 to ch4-13 are calculated, and a frequency channel is assigned in descending order of the priority numbers U for each bandwidth. Therefore, the search sequence is not restricted depending on the bandwidth, and an unused frequency channel can be detected in a short time.

### Embodiment 2

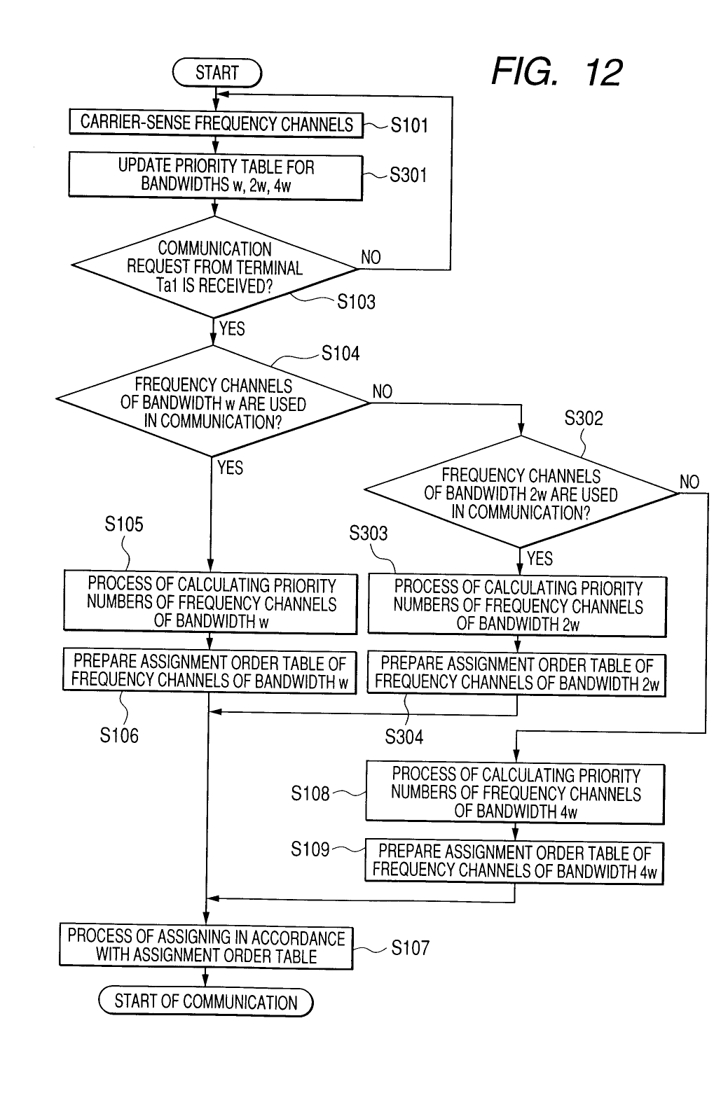

Embodiment 2 of the mobile communication system of the present invention will be described with reference to FIGS. 11 and 12. The mobile communication system of the embodiment is similar to the mobile communication system shown in FIG. 1 except that communication is performed with using frequency channels of bandwidths w, 2w, 4w.

In a base station CS4 in the embodiment, with respect to also frequency channels ch2-1 to ch2-15 of the bandwidth 2w, a priority table and an assignment order table are prepared, and a frequency channel is assigned to communication with a terminal in accordance with the assignment order, in the same manner as the frequency channels of the bandwidths w, 4w. The other configuration and operation are similar to those of the base station CS1 shown FIG. 3. Therefore, the same reference numerals are used, and their description is omitted.

The frequency channels 2w of the bandwidth 2w correspond to ch1-i to ch1-i+1 (i=1, . . . , 15) of two bandwidths w which are continuous to each other. Namely, the frequency channel ch2-1 corresponds to a combination of the frequency channel ch1-1 and the frequency channel ch1-2, and the frequency channel ch2-2 corresponds to the frequency channels ch1-2 and ch1-3.

The carrier-sensing unit 15 of the base station CS4 will be described in detail with reference to FIG. 11. In addition to the configuration of the carrier-sensing unit 15 shown in FIG. 4, the carrier-sensing unit 15 of the base station CS4 further comprises: a 2w-width monitor LPF 154-5 which reduces the reception power of the I-channel signal outside the bandwidth 2w; a 2w-width monitor LPF 154-6 which reduces the reception power of the Q-channel signal outside the bandwidth 2w; variable gain amplifiers 155-5, 155-6 which adjust the gains of the I- and Q-channel signals that have passed through the 2w-width monitor LPFs 154-5, 154-6, respectively; AD converters 156-5, 156-6 which convert the I- and Q-channel signals that are analog signals, to digital signals, respectively; a power measuring unit 157-3 which measures the reception power from the I- and Q-channel signals output from the AD converters 156-5, 156-6; a threshold comparing unit 158-3 which compares the reception power measured by the power measuring unit 157-3, with a 2w-monitor threshold Th-2w that is previously stored; and a 2w-width priority table updating unit 159-3 which updates the priority table for the bandwidth 2w on the basis of a result of the comparison by the threshold comparing unit 158-3, and stores the updated table into the priority storing unit 16.

The I-channel signal output from the quadrature demodulator 151 is supplied to the w-width monitor LPF 154-1, and the 4w-width monitor LPF 154-3, and also to the 2w-width monitor LPF 154-5. Similarly, the Q-channel signal output from the quadrature demodulator 152 is supplied to the 2w-width monitor LPF 154-6. The 2w-width monitor LPFs 154-5, 154-6 reduce the reception powers of the input I- and Q-channel signals outside the bandwidth 2w, and output the resulting signals to the variable gain amplifiers 155-5, 155-6, respectively.

The variable gain amplifiers 155-5, 155-6 adjust the gains of the input I- and Q-channel signals to a level at which the signals can be input to the AD converters in the subsequent stage, and output the adjusted I- and Q-channel signals to the AD converters 156-5, 156-6, respectively. The AD converters 156-5, 156-6 convert the input analog signal or I- and Q-channel signals to digital signals, and supply a result of the conversion to the power measuring unit 157-3.

The power measuring unit 157-3 measures the power of the reception signal on the basis of the I- and Q-channel signals supplied from the AD converters 156-5, 156-6, and outputs a result of the measurement to the threshold comparing unit 158-3. The threshold comparing unit 158-3 to which the measurement result is input compares the measurement result of the power measuring unit 157-3 with the 2w-monitor threshold Th-2w which is previously stored, and outputs a result of the comparison to the 2w-width priority table updating unit 159-3.

The 2w-width priority table updating unit 159-3 updates the priority table for the bandwidth 2w stored in the priority storing unit 16, on the basis of the input comparison result.

The priority storing unit 16 stores the priority table for the bandwidth 2w, in addition to the priority tables for the bandwidths w, 4w. Based on the priority tables for the bandwidths w, 2w, 4w stored in the priority storing unit 16, the priority number calculating unit 17 calculates the priority numbers U of the frequency channels of the bandwidth notified from a terminal which requests communication.

FIG. 12 is a flowchart showing the operation of the base station CS4 in the embodiment.

The base station CS4 operates in the same manner as the base station CS1 shown in FIG. 7 except that the carrier-sensing unit 15 updates the priority tables for the bandwidths w, 2w, 4w, and that, when the terminal Ta1 requests the frequency channels of the bandwidth 2w to be used in communication, the priority numbers U of the frequency channels of the bandwidth 2w are calculated, and an assignment order table is prepared on the basis of the calculated priority numbers U. Therefore, the same reference numerals are used, and their detailed description is omitted.

First, the base station CS4 carrier-senses the frequency channels ch1-1 to ch1-16 after each elapse of a predetermined time period (step S101), and updates the priority tables for the bandwidths w, 4w, and the priority table for the bandwidth 2w on the basis of a result of the carrier sense (step S301).

Next, when the communication request from the terminal Ta1 is received, the base station CS4 estimates the bandwidth of which frequency channels are to be used in communication, from the communication request transmitted from the terminal Ta1. In the case where the frequency channels of the bandwidth w are not to be used in communication (No in step S104), it is estimated whether the frequency channels of the bandwidth 2w are to be used or not (step S302). In the case where the frequency channels of the bandwidth 2w are not to be used in communication (No in step S302), the frequency channels of the bandwidth 4w are used, the priority numbers U of the frequency channels of the bandwidth 4w are calculated, an assignment order table is prepared, and communication is performed while assigning one of the frequency channels ch4-1 to ch4-13 to the communication with the terminal Ta1.

By contrast, in the case where the frequency channels of the bandwidth 2w are to be used in communication (Yes in step S302), the priority number calculating unit 17 of the base station CS4 refers the priority tables for the bandwidths 2w, 4w, and calculates the priority numbers U of the frequency channels ch2-1 to ch2-15 (step S303).

Then, the assignment order table preparing unit 18 sorts the frequency channels ch2-1 to ch2-15 calculated by the priority number calculating unit 17, in descending order of the priority numbers U, and prepares the assignment order table (step S304). In accordance with the assignment order table, the base station CS4 assigns a frequency channel to communication with the terminal Ta1 (step S107), and starts the communication.

Next, the processes of calculating the priority numbers of the bandwidths w, 2w, 4w performed in steps S105, S108, and S303 will be described in detail.

The priority number U_{w}(f1) of a frequency channel ch1-i (i=1, 2, . . . , 16) of the bandwidth w is calculated with using following expression (2) in place of expression (1).

U_{w}(fᵢ)=Y_{w}(fᵢ)−α₁Z_{2w}(fᵢ)−α₂Z_{4w}(fᵢ) (2)

where fᵢ indicates the center frequency of the frequency channel ch1-i, and Y_{w}(fᵢ) indicates the priority of the frequency channel ch1-i. Y_{w}(fᵢ) is obtained by referring the priority table for the bandwidth w.

Furthermore, Z_{2w}(fᵢ) indicates the maximum value of the priorities of frequency channels including the frequency fᵢ in the frequency channels of the bandwidth 2w, and obtained by referring the priority table for the bandwidth 2w, and Z_{4w}(fᵢ) indicates the maximum value of the priorities of frequency channels including the frequency fᵢ in the frequency channels of the bandwidth 4w, and obtained by referring the priority table for the bandwidth 4w. It is assumed that the coefficients α₁ and α₂ satisfy relationships of α₁≧0, α₂≧0, and α₁+α₂≦1. Although Z_{2w}(fᵢ) and Z_{4w}(fᵢ) are set as the maximum value of the priorities of frequency channels including the frequency fᵢ, Alternatively, they may be an average value or the like.

Next, the priority number U_{2w}(fⱼ) of a frequency channel ch2-j (j=1 to 15) of the bandwidth 2w is calculated with using following expression (3).

U_{2w}(fⱼ)=Y_{2w}(fⱼ)−βZ_{4w}(fⱼ) (3)

where fⱼ indicates the center frequency of the frequency channel ch2-j, and Y_{2w}(fⱼ) indicates the priority of the frequency channel ch2-j. Y_{2w}(fⱼ) is obtained by referring the priority table for the bandwidth 2w. It is assumed that the coefficient β satisfies a relationship of 0≦β≦1.

It is assumed that the priority numbers of the frequency channels ch4-1 to ch4-13 of the bandwidth 4w are the priorities of the frequency channels ch4-1 to ch4-13 stored in the priority table for the bandwidth 4w. Namely, the priority number U_{4w}(fₖ) of the frequency channel ch4-k of the bandwidth 4w is indicated by following expression (4).

U_{4w}(fₖ)=Y_{4w}(fₖ) (4)

where fₖ indicates the center frequency of the frequency channel ch4-k, and Y_{4w}(fₖ) indicates the priority of the frequency channel ch4-k.

As described above, according to Embodiment 2, even in a mobile communication system in which three kinds of frequency channels of different bandwidths exist, the priority of a frequency channel of a bandwidth which is wider than a bandwidth to be assigned to communication with a terminal is referred, and a frequency channel which is not assigned as a frequency channel of a wider bandwidth is preferentially assigned to communication with a terminal, whereby the same effects as Embodiment 1 can be attained.

### Modification

In Embodiments 1 and 2, the cases where frequency channels having two or three kinds of bandwidths are used in communication have been described. Alternatively, also in the case where frequency channels having n kinds of bandwidths, i.e., bandwidths w, 2w, . . . , nw are used, the frequency channels can be assigned to communication in a similar manner. In this case, the priority storing unit 16 stores priority tables for the bandwidths w, 2w, . . . , nw, and the priority number calculating unit 17 refers the priority tables, and calculates the priority number U_{pw}(fₓ) of a frequency channel of a bandwidth pw with using following expression (5) or (6).

In the case of the priority number U_{pw} of frequency channels of the bandwidths w, 2w, . . . , (n−1)w, expression (5) is used.

U_{pw}(fₓ)=Y_{pw}(fₓ)−αₙZ_{nw}(fₓ)−αₙ₋₁Z_{(n-1)w}(fₓ)− . . . −αₚ₊₁Z_{(p+1)w}(fₓ) (p=1, 2, . . . , n−1) (5)

In the case of the bandwidth nw, expression (6) is used.

U_{pw}(fₓ)=Y_{pw}(fₓ) (p=n) (6)

where fₓ indicates the center frequency of the frequency channel chp-x, and Y_{pw}(fₓ) indicates the priority of the frequency channel chp-x. Y_{pw}(fₓ) is obtained by referring the priority table for the bandwidth pw.

Furthermore, Z_{qw}(fₓ) indicates the maximum value of the priorities of frequency channels including the frequency fₓ in the frequency channels of the bandwidth qw, and obtained by referring the priority table for the bandwidth qw. It is assumed that the coefficient α_{q} satisfies relationships of α_{q}≧0, and αₚ₊₁+αₚ₊₂+ . . . +αₙ≦1. Although Z_{qw}(fₓ) is set as the maximum value of the priorities of frequency channels including the frequency fₓ, alternatively, it may be an average value or the like. In the above, q=1, 2, . . . , n.

### Embodiment 3

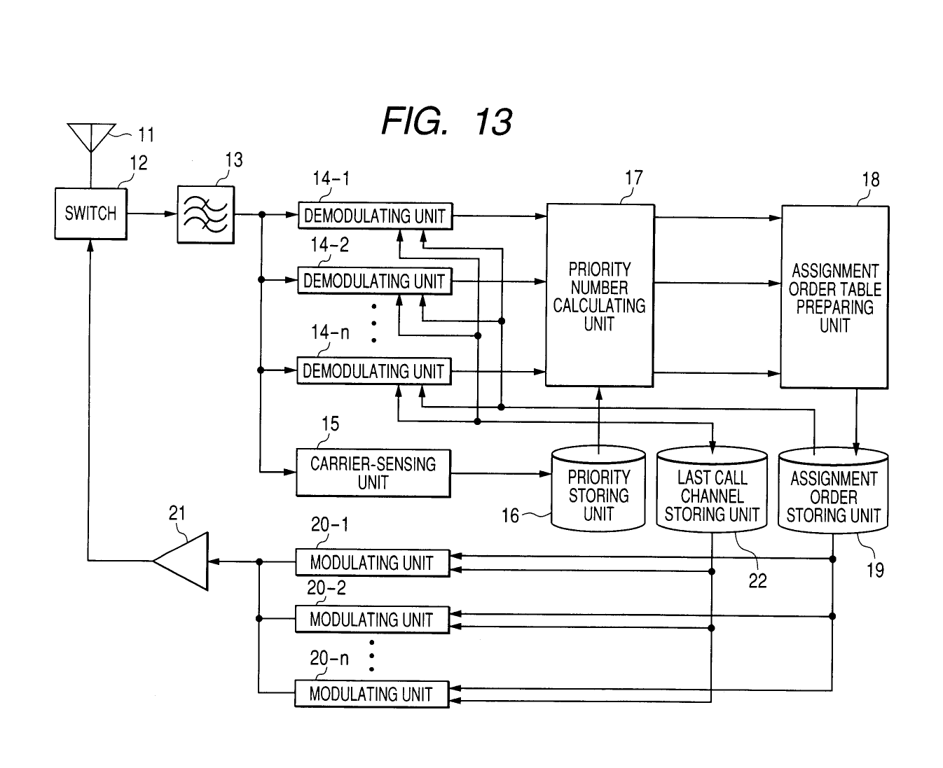

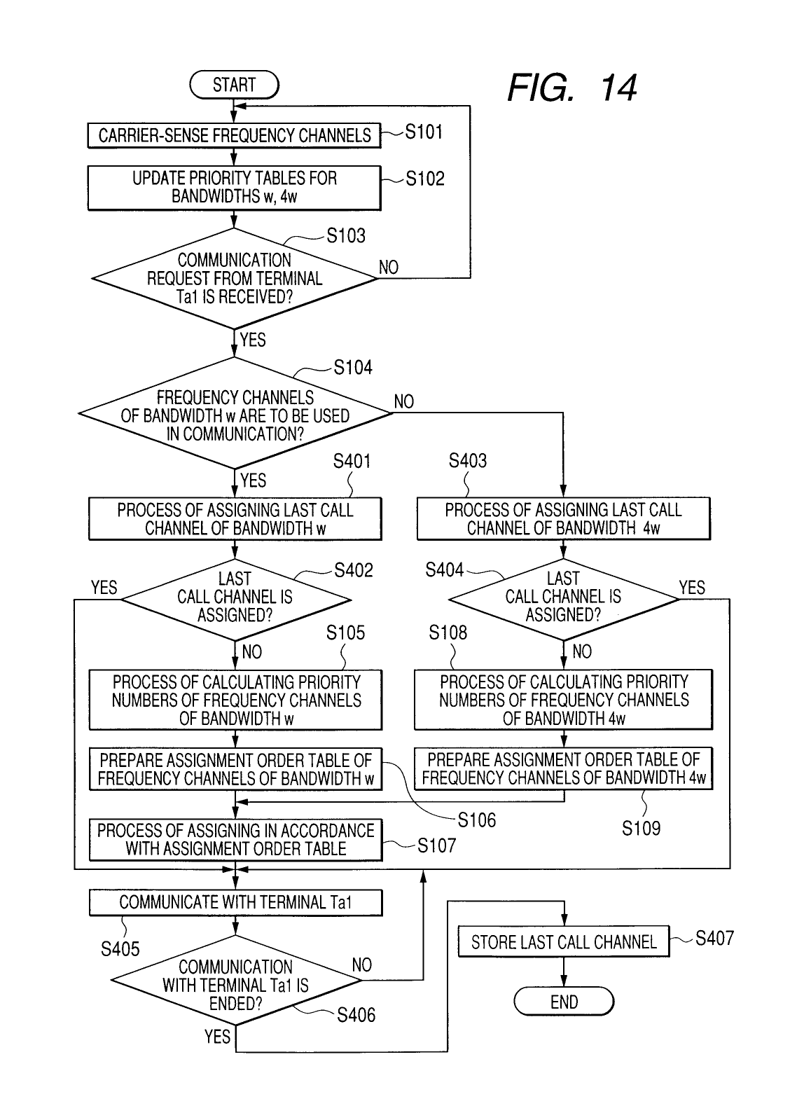

Embodiment 3 will be described with reference to FIGS. 13 and 14. A base station CS5 in Embodiment 3 is configured and operates in the same manner as the base station CS1 in Embodiment 1 except that a last call channel is stored for each of the bandwidths w, 4w. Therefore, the same reference numerals are used, and their description is omitted. The last call channel means a frequency channel which is used in communication immediately before the base station CS5 starts new communication with the terminal Ta1.

FIG. 13 is a diagram showing the configuration of the base station CS5 in Embodiment 3. In addition to the configuration of the base station CS1 shown in FIG. 3, the base station CS5 further comprises a last call channel storing unit 22 which stores the last call channel used in the previous communication, for each bandwidth.

Next, the operation conducted before the base station CS5 in Embodiment 3 starts communication with the terminal Ta1 will be described with reference to FIG. 14. The operation is similar to that of the flowchart shown in FIG. 7 except that carrier sense is performed on the last call channel, and that, after assignment of a frequency channel, the assigned frequency channel is stored as the last call channel.

In the case where the communication request from the terminal Ta1 is received, the base station CS5 estimates whether the terminal Ta1 notifies that the bandwidth w is to be used in communication or not (step S104). If the frequency channels of the bandwidth w are to be used in communication (Yes in step S104), the base station CS5 refers the last call channel storing unit, and performs a process of assigning the last call channel of the bandwidth w (step S401). This assigning process is similar to that shown in FIG. 10 in that carrier sense of a frequency channel used in communication is performed by both the base station CS5 and the terminal Ta1, but different therefrom in that the frequency channel on which the carrier sense is performed is the last call channel. When it is estimated from a result of carrier sense that the last call channel is not used in both the base station CS5 and the terminal Ta1, the base station CS5 assigns the last call channel to communication with the terminal Ta1. On the other hand, when it is estimated from a result of carrier sense that the last call channel is used even in one of the base station CS5 and the terminal Ta1, the last call channel is not assigned, and the process proceeds to next step S402.

In the next step S402, it is estimated whether the last call channel is assigned in the process of assigning the last call channel or not. If the last call channel is assigned (Yes in step S402), the base station CS5 stores the assigned last call channel into the last call channel storing unit 22 (step S405).

On the other hand, if the last call channel is not assigned (No in step S402), the base station CS5 prepares an assignment order table of the frequency channels ch1-1 to ch1-16 of the bandwidth w, and performs the assigning process (steps S105 to S107).

Next, the base station CS5 communicates with the terminal Ta1 with using the frequency channel of the bandwidth w which is assigned in the assigning process of step S107 (step S405). Then, it is estimated whether the communication with the terminal Ta1 is ended or not (step S406). If the communication is ended, the frequency channel used in the communication is set as a last call channel, and the last call channel is stored into the last call channel storing unit (step S407).

On the other hand, if the terminal Ta1 does not notify that the frequency channels of the bandwidth w are to be used in communication (No in step S104), communication is performed with using a frequency channel of the bandwidth 4w. Then, the base station CS5 performs the process of assigning the stored last call channel of the bandwidth 4w (step S403). The process after the assigning process is similar to that of the case of the bandwidth w, and hence its description is omitted.

As described above, according to Embodiment 3, before the process of assigning a frequency channel is performed, the process of assigning a frequency channel (last call channel) which is used in the immediately preceding communication is performed, and hence an unused frequency channel can be detected in a short time. This is because the possibility that a frequency channel (last call channel) which is used in the immediately preceding communication is again used before the next communication is lower than that of another frequency channel, and hence the possibility the communication can be started singly by the process of assigning the last call channel is increased.

In the Embodiment 3, the bandwidths of frequency channels to be used in communication are set to w and 4w. However, the invention is not restricted to this. Even when the bandwidths w, 2w, 4w or the bandwidths w, 2w, . . . , nw are used as shown in Embodiment 2, the same effects are attained.

The invention is not restricted to the embodiments as they are, and, in an implementation phase, may be embodied while modifying components without departing from the spirit of the invention. Furthermore, various inventions can be formed by adequately combining plural components disclosed in the embodiments. For example, several components may be deleted from all components shown in the embodiments, and components extending over different embodiments may be adequately combined with one another.

What is claimed is:

1. A base station configured to communicate with a plurality of terminals with using a plurality of frequency channels having different bandwidths, the base station comprising:
a carrier-sensing unit that carrier-senses the plurality of frequency channels;
a first calculating unit that estimates whether the carrier-sensed frequency channels are used in communication or not, respectively, and calculates a plurality of first priorities of respective frequency channels so that a first priority of a frequency channel which is estimated to be used is low and a first priority of a frequency channel which is estimated not to be used is high;
a priority storing unit that stores the first priorities of the plurality of frequency channels;
a second calculating unit that calculates a plurality of second priorities of respective communication frequency channels among the plurality of frequency channels based on the first priorities, the communication frequency channels having a bandwidth to be used in a communication with a terminal;
a third calculating unit that calculates an assignment order of the communication frequency channels based on the plurality of second priorities; and
a channel assigning unit that estimates whether the communication frequency channels are usable or not in the communication with the terminal in order of the assignment order, and when a communication frequency channel is estimated to be usable, assigns the communication frequency channel to the communication with the terminal,
wherein the second calculating unit calculates the second priorities of the communication frequency channels based on the first priorities of the communication frequency channels stored in the priority storing unit and the first priorities of reference frequency channels having a bandwidth wider than the bandwidth of the communication frequency channels.

2. The base station according to claim 1,
wherein the second priority of each of the communication frequency channels is calculated based on the first priority of the respective one of the communication frequency channels and the first priorities of overlapping frequency channels among the reference frequency channels, a part of each overlapping frequency channel overlapping with the respective one of the communication frequency channels.

3. The base station according to claim 2,
wherein each of the second priorities is calculated by subtracting an amount according to the first priorities of the overlapping frequency channels of the respective one of the communication frequency channels from the first priority of the respective one of the communication frequency channels.

4. The base station according to claim 1,
wherein the priority storing unit that stores the first priorities of the plurality of frequency channels divided in groups, each group including the frequency channels having a same bandwidth.

5. The base station according to claim 1,
wherein the second calculating unit calculates the second priorities of the communication frequency channels using following expressions:
U_{w(i)}(fᵢ)=Y_{w(i)}(fᵢ)−αᵢ₊₁Z_{w(i+1)}(fᵢ)−αᵢ₊₂Z_{w(i+2)}(fᵢ)− . . . −αₙZ_{w(n)}(fᵢ)
when i<n is satisfied,
U_{w(n)}(fₙ)=Y_{w(n)}(fₙ)
when i=n is satisfied,
where
w(i) (i=1, 2, . . . , n, w(i)<w(i+1)) indicates the bandwidths of the frequency channels,
fᵢ is center frequencies of the frequency channels,
Y_{w(i)}(fᵢ) is the first priority of the communication frequency channel having the center frequency fᵢ and the bandwidth w(i),
Z_{w(i)}(fᵢ) is a maximum or average value of the first priorities of the reference frequency channels having the bandwidth w(i) and including the frequency fᵢ,
αⱼ (j=i+1, i+2, . . . , n) are coefficients that satisfies relationships of αⱼ≧0 and αᵢ₊₁+αᵢ₊₂+ . . . +αₙ≦1.

6. The base station according to claim 1, further comprising:
a last call storing unit that stores a last call channel that is used before a start of communications with terminals for each bandwidth,
wherein the channel assigning unit estimates whether the last call channel stored in the last call storing unit for the bandwidth to be used in the communication is usable to the communication with the terminal or not,
wherein when the last call channel is estimated to be usable, the channel assigning unit assigns the last call channel to the communication with the terminal, and
wherein when the last call channel is estimated to be not usable, the channel assigning unit assigns the communication frequency channel to the communication with the terminal in accordance with the assignment order calculated by the third calculating unit.

7. The base station according to claim 1,
wherein the second calculation unit calculates the plurality of second priorities of respective communication frequency channels in response to a signal including a start request for a communication with the base station and information indicating a bandwidth to be used in the communication from a terminal.

8. A mobile communication system comprising:
a plurality of terminals; and
a base station configured to communicate with the terminals with using a plurality of frequency channels having different bandwidths;
wherein the plurality of terminals transmit signals to the base station, each of the signals including a start request for a communication with the base station and information indicating a bandwidth to be used in the communication,
wherein the base station comprises:
a receiving unit that receives the signals from the terminals;
a carrier-sensing unit that carrier-senses the plurality of frequency channels;
a first calculating unit that estimates whether the carrier-sensed frequency channels are used in communication or not, respectively, and calculates a plurality of first priorities of respective frequency channels so that a first priority of a frequency channel which is estimated to be used is low and a first priority of a frequency channel which is estimated not to be used is high;
a priority storing unit that stores the first priorities of the plurality of frequency channels;
a second calculating unit that calculates a plurality of second priorities of respective communication frequency channels among the plurality of frequency channels based on the first priorities, the communication frequency channels having a bandwidth to be used in a communication with a terminal;
a third calculating unit that calculates an assignment order of the communication frequency channels based on the plurality of second priorities; and
a channel assigning unit that estimates whether the communication frequency channels are usable or not in the communication with the terminal in order of the assignment order, and when a communication frequency channel is estimated to be usable, assigns the communication frequency channel to the communication with the terminal,
wherein the second calculating unit calculates the second priorities of the communication frequency channels based on the first priorities of the communication frequency channels stored in the priority storing unit and the first priorities of reference frequency channels having a bandwidth wider than the bandwidth of the communication frequency channels.

9. The mobile communication system according to claim 8,
wherein the second calculating unit calculates the second priority of each of the communication frequency channels based on the first priority of the respective one of the communication frequency channels and the first priorities of overlapping frequency channels among the reference frequency channels, a part of each of the overlapping frequency channels overlapping with the respective one of the communication frequency channels.

10. The mobile communication system according to claim 9,
wherein each of the second priorities is calculated by subtracting an amount according to the first priorities of the overlapping frequency channels of the respective one of the communication frequency channels from the first priority of the respective one of communication frequency channels.

11. The mobile communication system according to claim 8,
wherein the priority storing unit that stores the first priorities of the plurality of frequency channels divided in groups, each group including the frequency channels having a same bandwidth.

12. The mobile communication system according to claim 8,
wherein the second calculating unit calculates the second priorities of the communication frequency channels using following expressions:
U_{w(i)}(fᵢ)=Y_{w(i)}(fᵢ)−αᵢ₊₁Z_{w(i+1)}(fᵢ)−αᵢ₊₂Z_{w(i+2)}(fᵢ)− . . . −αₙZ_{w(n)}(fᵢ)
when i<n is satisfied,
U_{w(n)}(fₙ)=Y_{w(n)}(fₙ)
when i=n is satisfied,
where
w(i) (i=1, 2, . . . , n, w(i)<w(i+1)) indicates the bandwidths of the frequency channels,
fᵢ is center frequencies of the frequency channels,
Y_{w(i)}(fᵢ) is the first priority of the communication frequency channel having the center frequency fᵢ and the bandwidth w(i),
Z_{w(i)}(fᵢ) is a maximum or average value of the first priorities of the reference frequency channels having the bandwidth w(i) and including the frequency fᵢ,
αⱼ (j=i+1, i+2, . . . , n) are coefficients that satisfies relationships of αⱼ≧0 and αᵢ₊₁+αᵢ₊₂+ . . . +αₙ≦1.

13. The mobile communication system according to claim 8,
wherein the base station further comprises:
a last call storing unit that stores a last call channel that is used before a start of communications with terminals for each bandwidth,
wherein the channel assigning unit estimates whether the last call channel stored in the last call storing unit for the bandwidth to be used in the communication is usable to the communication with the terminal or not,
wherein when the last call channel is estimated to be usable, the channel assigning unit assigns the last call channel to the communication with the terminal, and
wherein when the last call channel is estimated to be not usable, the channel assigning unit assigns the communication frequency channel to the communication with the terminal in accordance with the assignment order calculated by the third calculating unit.

14. The mobile communication system according to claim 8,
wherein the second calculation unit calculates the plurality of second priorities of respective communication frequency channels in response to receiving a signal from a terminal.

15. A channel assignment method for a base station to assign a plurality of frequency channels having different bandwidths to a plurality of terminals for communication, the channel assignment method comprising:
carrier-sensing the plurality of frequency channels;
estimating whether the carrier-sensed frequency channels are used in communication or not, respectively to calculate a plurality of first priorities of respective frequency channels so that a first priority of a frequency channel which is estimated to be used is low and a first priority of a frequency channel which is estimated not to be used is high;
when the base station receives a signal including a start request for a communication from a terminal,
calculating a plurality of second priorities of respective communication frequency channels among the plurality of frequency channels based on the first priorities, the communication frequency channels having a bandwidth to be used in a communication with a terminal;
calculating an assignment order of the communication frequency channels based on the plurality of second priorities; and
estimating whether the communication frequency channels are usable or not in the communication with the terminal in order of the assignment order, and when a communication frequency channel is estimated to be usable, assigning the communication frequency channel to the communication with the terminal,
wherein the second priorities of the communication frequency channels are calculated based on the first priorities of the communication frequency channels and the first priorities of reference frequency channels having a bandwidth wider than the bandwidth of the communication frequency channels.

16. The channel assignment method according to claim 15,
wherein the second priority of each of the communication frequency channels is calculated based on the first priority of the respective one of the communication frequency channels and the first priorities of overlapping frequency channels among the reference frequency channels, a part of each overlapping frequency channel overlapping with the respective one of the communication frequency channels.

17. The channel assignment method according to claim 16,
wherein each of the second priorities is calculated by subtracting an amount according to the first priorities of the overlapping frequency channels of the respective one of the communication frequency channels from the first priority of the respective one of communication frequency channels.

18. The channel assignment method according to claim 15,
wherein the second priorities of the communication frequency channels is calculated by using following expressions:
U_{w(i)}(fᵢ)=Y_{w(i)}(fᵢ)−αᵢ₊₁Z_{w(i+1)}(fᵢ)−αᵢ₊₂Z_{w(i+2)}(fᵢ)− . . . −αₙZ_{w(n)}(fᵢ)
when i<n is satisfied,
U_{w(n)}(fₙ)=Y_{w(n)}(fₙ)
when i=n is satisfied,
where
w(i) (i=1, 2, . . . , n, w(i)<w(i+1)) indicates the bandwidths of the frequency channels,
fᵢ is center frequencies of the frequency channels,
Y_{w(i)}(fᵢ) is the first priority of the communication frequency channel having the center frequency fᵢ and the bandwidth w(i),
Z_{w(i)}(fᵢ) is a maximum or average value of the first priorities of the reference frequency channels having the bandwidth w(i) and including the frequency fᵢ,
αⱼ (j=i+1, i+2, . . . , n) are coefficients that satisfies relationships of αⱼ≧0 and αᵢ₊₁+αᵢ₊₂+ . . . +αₙ≦1.

19. The channel assignment method according to claim 15, wherein the base station stores a last call channel that is used before a start of communications with terminals for each bandwidth,
the channel assignment method further comprising estimating whether the last call channel stored in the last call storing unit for the bandwidth to be used in the communication is usable to the communication with the terminal or not,
when the last call channel is estimated to be usable, assigning the last call channel to the communication with the terminal, and
when the last call channel is estimated to be not usable, assigning the communication frequency channel to the communication with the terminal in accordance with the assignment order.

20. The channel assignment method according to claim 15,
wherein the plurality of second priorities of respective communication frequency channels are calculated in response to the signal including the start request for the communication from the terminal.
